(19) United States
(12) Patent Application Publication
(10) Pub. No.: US 2005/0141136 A1
(43) Pub. Date: Jun. 30, 2005

(54) Spindle motor and disk apparatus provided with the same

(75) Inventor: Hiroyuki Kitamura, Ome-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/019,591

(22) Filed: Dec. 23, 2004

(30) Foreign Application Priority Data
Dec. 25, 2003 (JP) 2003-431181

(51) Int. Cl. G11B 17/02

(52) U.S. Cl. 360/99.08

(57) ABSTRACT

A spindle motor includes a fixed shaft, a rotating sleeve, and an outer ring member. The rotating sleeve has an inner peripheral surface opposed to an outer peripheral surface of the fixed shaft across a first fine gap, an outer peripheral surface, and a bottom surface. The outer ring member has an opposite surface opposed to the bottom surface of the rotating sleeve across a second fine gap and an inner peripheral surface opposed to the outer peripheral surface of the rotating sleeve across a third fine gap and is provided fixedly. The first, second, and third fine gaps are filled with a dynamic pressure generating fluid. A first radial dynamic pressure generating portion is located singly in the first fine gap, and a second radial dynamic pressure generating portion in the third fine gap. A thrust dynamic pressure generating portion is located in the second fine gap.

### CROSS-REFERENCE TO RELATED APPLICATIONS

This application is based upon and claims the benefit of priority from prior Japanese Patent Application No. 2003-431181, filed Dec. 25, 2003, the entire contents of which are incorporated herein by reference.

### BACKGROUND OF THE INVENTION

1. Field of the Invention

This invention relates to a spindle motor, and more particularly, to a spindle motor of an inner-rotor type having a dynamic pressure fluid bearing and a disk apparatus provided with the spindle motor.

2. Description of the Related Art

Disk apparatuses, such as magnetic disk apparatuses, optical disk apparatuses, etc., are provided with a spindle motor that supports and drives a disk as a rotating body. The spindle motor, e.g., a fixed-shaft spindle motor, usually comprises a fixed shaft and a rotor that is rotatably supported on the shaft. The rotor is supported on the fixed shaft by radial bearings that support a radial load and a thrust bearing that supports an axial load. A plurality of radial bearings are arranged spaced in the axial direction of the fixed shaft, in order to prevent the rotor from tilting with respect to the shaft, that is, to prevent the rotor from rocking around an axis perpendicular to the shaft. In a spindle motor described in Jpn. Pat. Appln. KOKAI Publication No. 2000-186716, for example, a fine gap is defined between the outer peripheral surface of a fine gap and the inner peripheral surface of a rotor, and two radial bearings are provided in the fine gap. These two radial bearings are arranged in the axial direction of the fixed shaft.

In recent years, fluid bearings have been widely used as bearings for spindle motors. A fluid bearing generates a dynamic pressure with use of a fluid, such as air or lubricating oil, filled in fine gaps, thereby supporting a rotating body. Thus, the rotating body can be supported with stability, and the spindle motor can be miniaturized.

As described above, the spindle motor is provided with a plurality of radial bearings that are fluid bearings, so that the rotor can be steadily rotated at high speed. With the miniaturization of modern disk apparatuses, spindle motors are expected to be further reduced in size. In the aforementioned configuration in which a plurality of radial bearings are arranged in the axial direction of the fixed shaft, however, the size in the axial direction of the shaft is large and cannot be reduced with ease. Possibly, the axial dimension may be reduced by using only one radial bearing. In this case, however, there is a possibility of the rotor swinging or tilting around the single bearing, so that the rotor cannot be easily supported and rotated with stability.

### BRIEF SUMMARY OF THE INVENTION

According to an aspect of the invention, a spindle motor comprises: a fixed shaft at least one end of which is fixed; a rotating sleeve which is rotatably arranged outside the fixed shaft and which has an inner peripheral surface opposed to an outer peripheral surface of the fixed shaft across a first fine gap, an outer peripheral surface, and a bottom surface extending between the inner and outer peripheral surfaces and; an outer ring member which is provided fixedly and which has an opposite surface opposed to the bottom surface of the rotating sleeve across a second fine gap and an inner peripheral surface opposed to the outer peripheral surface of the rotating sleeve across a third fine gap; a dynamic pressure generating fluid filled in the first, second, and third fine gaps; a hub fixed to the rotating sleeve; a magnetic attraction portion which has a magnet fixed to the hub and a magnetic member fixedly arranged and opposed to the magnet and urges the rotating sleeve in the axial direction of the fixed shaft and in a direction such that the second fine gap narrows, by a force of magnetic attraction between the magnet and the magnetic member; a first radial dynamic pressure generating portion located singly in the first fine gap; a second radial dynamic pressure generating portion located singly in the third fine gap; and a thrust dynamic pressure generating portion located in the second fine gap.

According to another aspect of the invention, a spindle motor comprises: a fixed shaft at least one end of which is fixed; a rotating sleeve which is rotatably located outside the fixed shaft and which has an inner peripheral surface opposed to an outer peripheral surface of the fixed shaft across a first fine gap, an outer peripheral surface, a first end face extending between the inner and outer peripheral surfaces, and a second end face spaced in the axial direction of the fixed shaft from the first end face and extending between the inner and outer peripheral surfaces; an outer ring member which is fixedly arranged and which has a first opposite surface opposed to the first end face of the rotating sleeve across a second fine gap, an inner peripheral surface opposed to the outer peripheral surface of the rotating sleeve across a third fine gap, and a second opposite surface opposed to the second end face of the rotating sleeve across a fourth fine gap; a dynamic pressure generating fluid filled in the first, second, third, and fourth fine gaps; a hub fixed to the rotating sleeve; a first radial dynamic pressure generating portion located singly in the first fine gap; a second radial dynamic pressure generating portion located singly in the third fine gap; a first thrust dynamic pressure generating portion located in the second fine gap; and a second thrust dynamic pressure generating portion located in the fourth fine gap.

According to still another aspect of the invention, a disk apparatus comprises: a disk-shaped recording medium; and the spindle motor which supports and drives the recording medium.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a plan view showing a hard disk drive (hereinafter referred as an HDD) according to a first embodiment of the invention;

FIG. 2 is a sectional view showing a spindle motor of the HDD;

FIG. 3 is a side view showing a fixed shaft of the spindle motor;

FIG. 4 is a side view showing a rotating sleeve of the spindle motor;

FIGS. 5A and 5B are plan views showing thrust dynamic pressure generating grooves on an outer ring member of the spindle motor; and

FIG. 6 is a sectional view showing an HDD according to a second embodiment of the invention.

### DETAILED DESCRIPTION OF THE INVENTION

A first embodiment in which a disk apparatus according to this invention is applied to an HDD will now be described in detail with reference to the accompanying drawings.

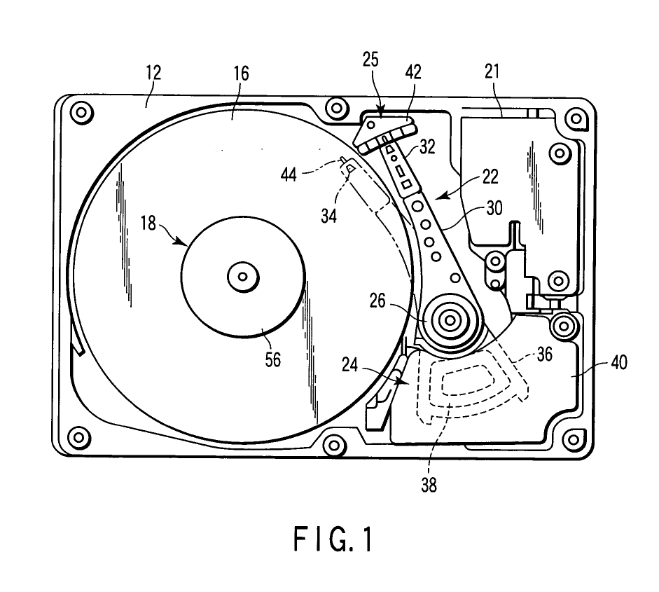

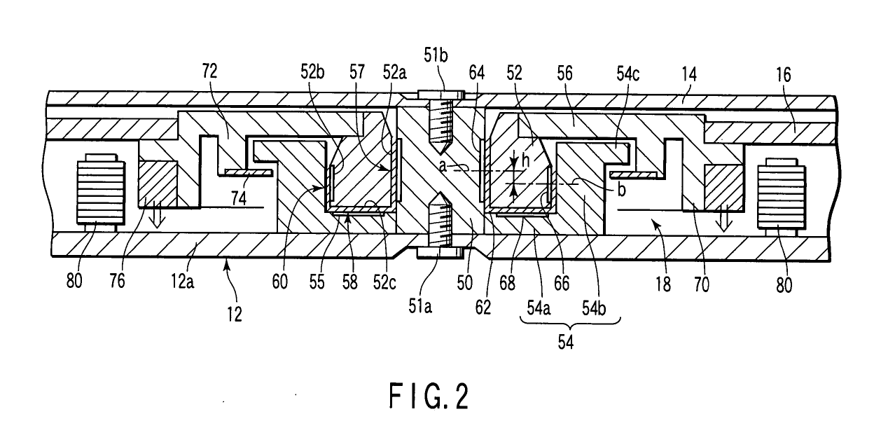

As shown in FIGS. 1 and 2, the HDD comprises a case 12 in the form of an open-topped rectangular box and a top cover 14 screwed to the case by screws. The top cover 14 closes a top opening of the case. The case 12 has a flat bottom wall 12a in the shape of a flat sheet, which functions as a base. The case 12 is formed of a magnetic material, such as iron.

The case 12 contains a magnetic disk 16 for use as a recording medium, a spindle motor 18, magnetic heads, and a carriage assembly 22. The motor 18 supports and rotates the disk. The magnetic heads are used to write and read information to and from the disk. The carriage assembly 22 supports the magnetic heads for movement with respect to the magnetic disk 16. Further, the case 12 houses a voice coil motor (hereinafter referred to as VCM) 24, a ramp load mechanism 25, a substrate unit 21, etc. The VCM 24 rocks and positions the carriage assembly. The ramp load mechanism 25 holds the magnetic heads in a shunt position off the magnetic disk when the magnetic heads are moved to the outermost periphery of the disk. The substrate unit 21 has a read/write amplifier, for use as a processing circuit for recording/reproduction signals, and the like.

A printed circuit board (not shown) that controls the operations of the spindle motor 18, VCM 24, and magnetic heads through the substrate unit 21 is provided on the outer surface side of the bottom wall 12a of the case 12.

The magnetic disk 16 has a magnetic recording layer that is formed on its upper and/or lower surface, and is, for example, about 0.85 inch in diameter. The disk 16 is fitted on a hub of the spindle motor 18, which will be mentioned later, and is fixedly supported on the hub by means of a clamp spring (not shown). As the motor 18 is driven, the disk 16 is rotated at a given speed, e.g., at 4,200 rpm.

The carriage assembly 22 comprises a bearing portion 26 fixed on the bottom wall 12a of the case 12, arms 30 extending from the bearing portion, and a suspension 32 extending from each of the arms. A magnetic head 34 is supported on an extended end of the suspension 32 by means of a gimbals portion (not shown).

As shown in FIG. 1, the carriage assembly 22 has a support frame 36 that extends in the opposite direction from the bearing portion 26 with respect to the arms 30. The support frame 36 supports a voice coil 38 that constitutes a part of the VCM 24. The support frame 36 is molded from synthetic resin and formed integrally on the outer periphery of the voice coil 38. The coil 38 is situated between a pair of yokes 40 that are fixed on the case 12. It forms the VCM 24 in conjunction with the yokes and a magnet (not shown) that is fixed to one of the yokes. When the voice coil 38 is energized, the carriage assembly 22 rocks around the bearing portion 26, whereupon the magnetic head 34 is moved and positioned onto a desired track of the magnetic disk 16.

The ramp load mechanism 25 includes a ramp 42 and a tab 44. The ramp 42 is provided on the bottom wall of the case 12 and located outside the magnetic disk 16. The tab 44 extends from the distal end of the suspension 32. As the carriage assembly 22 rotates to the retreated position outside the disk 16, the tab 44 engages a ramp surface of the ramp 42, and is then pulled up by the inclination of the ramp surface. Thereupon, the magnetic head is unloaded.

The following is a detailed description of the spindle motor 18.

As shown in FIG. 2, the spindle motor 18 comprises a fixed shaft 50, rotating sleeve 52, outer ring member 54, and hub 56. The sleeve 52 is rotatably supported by the fixed shaft. The outer ring member 54 is fixed to the shaft 50 and the bottom wall 12a. The hub 56 is fixed to the sleeve 52. The fixed shaft 50 is set substantially upright on the inner surface of the bottom wall 12a, and its lower end is fixed to the wall 12a with a screw 51a. The upper end of the shaft 50 is fixed to the top cover 14 with a screw 51b.

The outer ring member 54 integrally has an annular base portion 54a, a cylindrical portion 54b extending from the outer periphery of the base portion, and an annular flange 54c on the outer periphery of an extended end of the cylindrical portion. The base portion 54a is fitted on the outer periphery of the lower end portion of the fixed shaft 50 and is in contact with the inner surface of the bottom wall 12a. The upper surface of the base portion 54a extends radially with respect to the shaft 50 and forms an annular opposite surface 55. The cylindrical portion 54b is coaxial with the fixed shaft 50 and faces the outside of the shaft across a gap.

The rotating sleeve 52 is coaxial with the fixed shaft 50 and is situated between the cylindrical portion 54b of the outer ring member 54 and the fixed shaft. The sleeve 52 has an inner peripheral surface 52a, an outer peripheral surface 52b, and a bottom surface 52c. The inner peripheral surface 52a faces the outer peripheral surface of the shaft 50 across a first fine gap 57. The outer peripheral surface 52b faces the inner peripheral surface of the cylindrical portion 54b across a third fine gap 60. The bottom surface 52c extends between the peripheral surfaces 52a and 52b. The bottom surface 52c faces the opposite surface 55 of the base portion 54a across a second fine gap 58. The first and third fine gaps 57 and 60 have their respective open ends that are open to the atmosphere and closed ends that communicate with each other through the second fine gap 58. The first, second, and third fine gaps 57, 58 and 60 are filled with a lubricating oil 62 for use as a dynamic pressure generating fluid. The width of each fine gap ranges from about 2 to 15 μm.

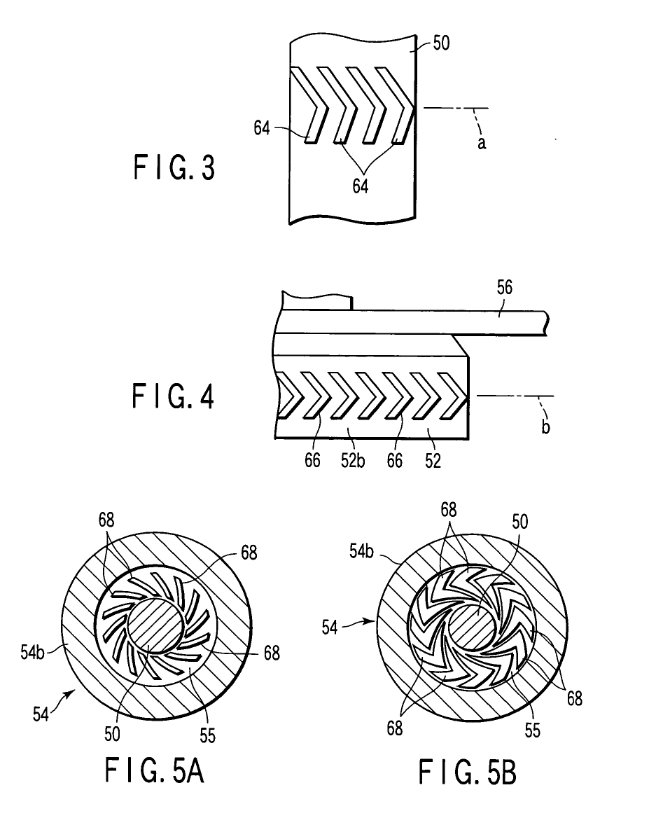

The first fine gap 57 is provided with only one first radial dynamic pressure generating portion. The third fine gap 60 is provided with only one second radial dynamic pressure generating portion. Further, the second fine gap 58 is provided with a thrust dynamic pressure generating portion. As shown in FIGS. 2 and 3, the first radial dynamic pressure generating portion has a plurality of first radial dynamic pressure generating grooves 64 that are formed of herringbone grooves on the outer peripheral surface of the fixed shaft 50. The grooves 64 are arranged in the circumferential direction of the shaft 50, covering its whole circumference. When the rotating sleeve 52 rotates, the grooves 64 cause the lubricating oil 62 in the first fine gap 57 to generate a radial dynamic pressure. The first radial dynamic pressure generating portion has a dynamic pressure generation center a.

As shown in FIGS. 2 and 4, the second radial dynamic pressure generating portion has a plurality of second radial dynamic pressure generating grooves 66 that are formed of herringbone grooves on the outer peripheral surface 52b of the rotating sleeve 52. The grooves 66 are arranged in the circumferential direction of the sleeve 52, covering its whole circumference. When the rotating sleeve 52 rotates, the grooves 66 cause the lubricating oil 62 in the third fine gap 60 to generate a radial dynamic pressure. The second radial dynamic pressure generating portion has a dynamic pressure generation center b.

The first radial dynamic pressure generating portion in the first fine gap 57 and the second radial dynamic pressure generating portion in the third fine gap 60 are arranged overlapping each other in the radial direction of the fixed shaft 50. Further, the first radial dynamic pressure generating portion is located so that its dynamic pressure generation center a is kept at a distance h in the axial direction of the shaft 50 from the dynamic pressure generation center b of the second radial dynamic pressure generating portion. The distance h is set to 0.1 mm to 1 mm, for example.

As shown in FIGS. 2 and 5A, the thrust dynamic pressure generating portion has a plurality of thrust dynamic pressure generating grooves 68 that are formed of spiral grooves on the opposite surface 55 of the outer ring member 54. The grooves 68 extend spirally around the fixed shaft 50 and are arranged in the circumferential direction of the opposite surface 55. When the rotating sleeve 52 rotates, the grooves 68 cause the lubricating oil 62 in the second fine gap 58 to generate a thrust-direction dynamic pressure. As shown in FIG. 5B, the thrust dynamic pressure generating grooves 68 of the thrust dynamic pressure generating portion may alternatively be formed of herringbone grooves that are arranged on the opposite surface 55 of the outer ring member 54 in its circumferential direction.

As shown in FIG. 2, the hub 56 of the spindle motor 18 is in the form of a ring, which is fixed on the outer periphery of the upper end portion of the rotating sleeve 52. The hub 56 is coaxial with the fixed shaft 50 and extends outward beyond the cylindrical portion 54b of the outer ring member 54 in the radial direction of the shaft. An annular skirt portion 70 that extends toward the bottom wall 12a of the case 12 is formed integrally on the outer peripheral portion of the hub 56. Further, an annular protrusion 72 protrudes from the lower surface of the hub 56 and is situated coaxially with the fixed shaft 50 between the cylindrical portion 54b of the rotating sleeve 52 and the skirt portion 70. An annular stopper sheet 74 is fixed to the lower end of the protrusion 72. The stopper sheet 74 faces the flange 54c of the cylindrical portion 54b in the axial direction of the fixed shaft 50, thereby restraining the rotating sleeve 52 and the hub 56 from slipping off the shaft 50 and the outer ring member 54. The rotating sleeve 52 and the hub 56 may be molded integrally with each other. The magnetic disk 16 is fixed to the hub 56 with its center hole fitted on the outer peripheral surface of the hub.

An annular permanent magnet 76 is fixed on the outer periphery of the lower end portion of the skirt portion 70, which constitutes a part of the hub 56, and is situated coaxially with the fixed shaft 50. The permanent magnet 76 faces the inner surface of the bottom wall 12a of the case 12 across a given gap. As mentioned before, the bottom wall 12a is formed of a magnetic material and constitutes a magnetic member. The magnet 76, which functions as a magnetic attraction portion, and the hub 56, to which the magnet is fixed, are urged toward the bottom wall 12a by a force of magnetic attraction between the magnet and the bottom wall. Thus, the hub 56 and the rotating sleeve 52 are urged in the axial direction of the fixed shaft 50 and in a direction such that the second fine gap 58 narrows.

On the inner surface of the bottom wall 12a, a plurality of stator coils 80 are arranged outside the hub 56 and face the permanent magnet 76 across a given gap. When the stator coils 80 are energized, the hub 56 and the rotating sleeve 52 are rotated by interaction between magnetic fields that are formed by the coils and the magnet 76, individually.

According to the HDD with the spindle motor 18 constructed in this manner, a radial dynamic pressure is generated in the first and third fine gaps 57 and 60 when the hub 56 and the rotating sleeve 52 rotate. Under this dynamic pressure, the hub 56 and the rotating sleeve 52 support a radial load. At the same time, the hub 56 and the sleeve 56 support a thrust-direction load under the thrust-direction dynamic pressure generated in the second fine gap 58 and the force of magnetic attraction generated by the magnetic attraction portion. Thus, the hub 56 and the sleeve 52 can smoothly, steadily rotate at high speed without looseness. Likewise, the magnetic disk 16 that is supported by the hub 56 can steadily rotate at high speed. Thus, the magnetic head 34 can perform stable information recording and reproduction.

In the spindle motor 18, the first and second radial dynamic pressure generating portions are arranged so that they are spaced and lapped in the radial direction of the fixed shaft 50 without overlapping in the axial direction of the shaft. Therefore, the dimension of the spindle motor in the axial direction of the shaft 50, that is, its height, can be reduced to miniaturize the motor. Further, the respective dynamic pressure generation centers a and b of the first and second radial dynamic pressure generating portions are deviated from each other by the distance h in the axial direction of the shaft 50. Accordingly, the rotating sleeve 52 can be prevented from swinging or tilting around the radial dynamic pressure generating portions, so that the hub 56 and the sleeve 52 can be supported and rotated with stability.

Thus, the hub and the magnetic disk as rotating bodies can be supported stably, and the resulting spindle motor can be reduced in size. Further, there may be obtained a small-sized magnetic disk apparatus that ensures stable information recording and reproduction.

In the first embodiment described above, the first radial dynamic pressure generating portion is not limited to the outer peripheral surface of the fixed shaft, and may be formed of dynamic pressure generating grooves that are formed on the inner peripheral surface of the rotating sleeve or on both these peripheral surfaces. The second radial dynamic pressure generating portion is not limited to the outer peripheral surface of the rotating sleeve, and may be formed of dynamic pressure generating grooves that are formed on the inner peripheral surface of the outer ring member or on both these peripheral surfaces. Further, the thrust dynamic pressure generating portion is not limited to the opposite surface of the outer ring member, and may be formed of dynamic pressure generating grooves that are formed on the bottom surface of the rotating sleeve or on both these surfaces.

The following is a description of an HDD according to a second embodiment of the invention.

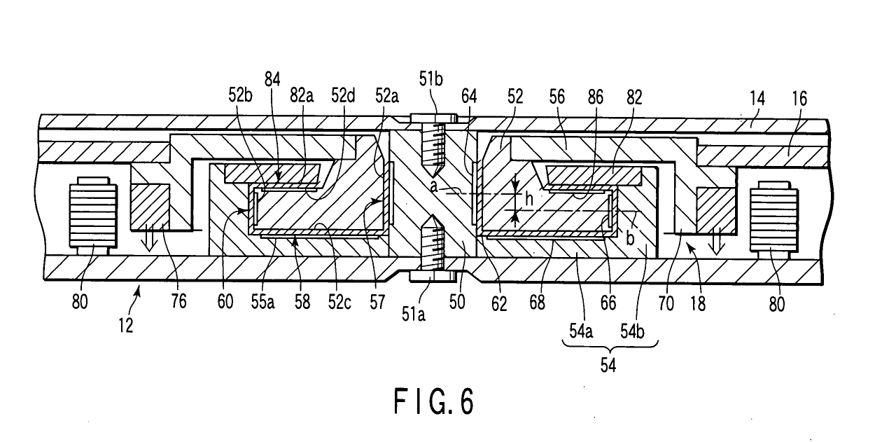

According to the second embodiment, as shown in FIG. 6, a spindle motor 18 of the HDD comprises a fixed shaft 50, rotating sleeve 52, outer ring member 54, and hub 56. The sleeve 52 is rotatably supported by the fixed shaft. The outer ring member 54 is fixed to the shaft and a bottom wall 12a of a case 12. The hub 56 is fixed to the sleeve 52.

The outer ring member 54 is provided with an annular base portion 54a, a cylindrical portion 54b extending from the outer periphery of the base portion, and an annular stopper sheet 82 extending from an extended end of the cylindrical portion toward the fixed shaft 50 and opposed to the base portion 54a. The base portion 54a is fitted on the outer periphery of the lower end portion of the fixed shaft 50 and is in contact with the inner surface of the bottom wall 12a. The upper surface of the base portion 54a extends radially with respect to the shaft 50 and forms an annular first opposite surface 55a. The cylindrical portion 54b is coaxial with the fixed shaft 50 and faces the outside of the shaft across a gap. The inner surface of the stopper sheet 82 forms an annular second opposite surface 82a, which faces the first opposite surface 55a.

The rotating sleeve 52 is coaxial with the fixed shaft 50 and is situated between the cylindrical portion 54b of the outer ring member 54 and the fixed shaft. The sleeve 52 has an inner peripheral surface 52a, outer peripheral surface 52b, first end face 52c, and second end face 52d. The inner peripheral surface 52a faces the outer peripheral surface of the shaft 50 across a first fine gap 57. The outer peripheral surface 52b faces the inner peripheral surface of the cylindrical portion 54b across a third fine gap 60. The first end face 52c extends between the respective lower ends of the inner peripheral surface 52a and the outer peripheral surface 52b. The second end face 52d extends from the upper end of the outer peripheral surface 52b toward the fixed shaft.

The first end face 52c faces the first opposite surface 55a of the base portion 54a across a second fine gap 58. The second end face 52d faces the second opposite surface 82a of the stopper sheet 82 across a fourth fine gap 84. The first and fourth fine gaps 57 and 84 have their respective open ends that are open to the atmosphere. The first and third fine gaps 57 and 60 have their respective closed ends that communicate with each other through the second fine gap 58. The first, second, third, and fourth fine gaps 57, 58, 60 and 84 are filled with a lubricating oil 62 for use as a dynamic pressure generating fluid. The width of each fine gap ranges from about 2 to 15 μm. The stopper sheet 82 restrains the rotating sleeve 52 and the hub 56 from slipping off the fixed shaft 50 and the outer ring member 54.

The first fine gap 57 is provided with only one first radial dynamic pressure generating portion. The third fine gap 60 is provided with only one second radial dynamic pressure generating portion. The second fine gap 58 is provided with a first thrust dynamic pressure generating portion, and the fourth fine gap 84 with a second thrust dynamic pressure generating portion. As in the first embodiment, the first radial dynamic pressure generating portion has a plurality of first radial dynamic pressure generating grooves 64 that are formed of herringbone grooves on the outer peripheral surface of the fixed shaft 50. The grooves 64 are arranged in the circumferential direction of the shaft 50, covering its whole circumference. When the rotating sleeve 52 rotates, the grooves 64 cause the lubricating oil 62 in the first fine gap 57 to generate a radial dynamic pressure. The first radial dynamic pressure generating portion has a dynamic pressure generation center a.

The second radial dynamic pressure generating portion has a plurality of second radial dynamic pressure generating grooves 66 that are formed of herringbone grooves on the outer peripheral surface 52b of the rotating sleeve 52. The grooves 66 are arranged in the circumferential direction of the sleeve 52, covering its whole circumference. When the rotating sleeve 52 rotates, the grooves 66 cause the lubricating oil 62 in the third fine gap 60 to generate a radial dynamic pressure. The second radial dynamic pressure generating portion has a dynamic pressure generation center b.

The first radial dynamic pressure generating portion in the first fine gap 57 and the second radial dynamic pressure generating portion in the third fine gap 60 are arranged overlapping each other in the radial direction of the fixed shaft 50. Further, the first radial dynamic pressure generating portion is located so that its dynamic pressure generation center a is kept at a distance h in the axial direction of the shaft 50 from the dynamic pressure generation center b of the second radial dynamic pressure generating portion. The distance h is set to 0.1 mm to 1 mm, for example.

The first thrust dynamic pressure generating portion has a plurality of thrust dynamic pressure generating grooves 68 that are formed of spiral grooves on the first opposite surface 55a of the outer ring member 54. The grooves 68 extend spirally around the fixed shaft 50 and are arranged in the circumferential direction of the opposite surface 55a. When the rotating sleeve 52 rotates, the grooves 68 cause the lubricating oil 62 in the second fine gap 58 to generate a thrust-direction dynamic pressure.

The second thrust dynamic pressure generating portion has a plurality of thrust dynamic pressure generating grooves 86 that are formed of spiral grooves on the second end face 52d of the rotating sleeve 52. The grooves 86 extend spirally around the fixed shaft 50 and are arranged in the circumferential direction of the second end face 52d. When the rotating sleeve 52 rotates, the grooves 86 cause the lubricating oil 62 in the fourth fine gap 84 to generate a thrust-direction dynamic pressure. The thrust dynamic pressure generating grooves of the first and second thrust dynamic pressure generating portions may alternatively be formed of herringbone grooves.

The hub 56 of the spindle motor 18 is in the form of a ring, which is fixed on the outer periphery of the upper end portion of the rotating sleeve 52. The hub 56 is coaxial with the fixed shaft 50 and extends outward beyond the cylindrical portion 54b of the outer ring member 54 in the radial direction of the shaft. An annular skirt portion 70 that extends toward the bottom wall 12a of the case 12 is formed integrally on the outer peripheral portion of the hub 56. The magnetic disk 16 is fixed to the hub 56 with its center hole fitted on the outer peripheral surface of the hub. The rotating sleeve 52 and the hub 56 may be molded integrally with each other.

An annular permanent magnet 76 is fixed on the outer periphery of the lower end portion of the skirt portion 70 and is situated coaxially with the fixed shaft 50. The permanent magnet 76 faces the inner surface of the bottom wall 12a of the case 12 across a given gap. The bottom wall 12a is formed of a magnetic material and constitutes a magnetic member. The magnet 76, which functions as a magnetic attraction portion, and the hub 56, to which the magnet is fixed, are urged toward the bottom wall 12a by a force of magnetic attraction between the magnet and the bottom wall. Thus, the hub 56 and the rotating sleeve 52 are urged in the axial direction of the fixed shaft 50 and in a direction such that the second fine gap 58 narrows.

On the inner surface of the bottom wall 12a, a plurality of stator coils 80 are arranged outside the hub 56 and face the permanent magnet 76 across a given gap. When the stator coils 80 are energized, the hub 56 and the rotating sleeve 52 are rotated by interaction between magnetic fields that are formed by the coils and the magnet 76, individually.

The second embodiment shares the other configurations of the spindle motor 18 and the HDD with the first embodiment. Therefore, like reference numerals are used to designate like portions of the two embodiments, and a detailed description of those portions is omitted.

According to the HDD with the spindle motor 18 constructed in this manner, a radial dynamic pressure is generated in the first and third fine gaps 57 and 60 when the hub 56 and the rotating sleeve 52 rotate. Under this dynamic pressure, the hub 56 and the rotating sleeve 52 support a radial load. At the same time, the hub 56 and the sleeve 52 support a thrust-direction load under the thrust-direction dynamic pressures generated in the second and fourth fine gaps 58 and 84 and the force of magnetic attraction generated by the magnetic attraction portion. Thus, the hub 56 and the sleeve 52 can smoothly, steadily rotate at high speed without looseness. Likewise, the magnetic disk 16 that is supported by the hub 56 can steadily rotate at high speed. Thus, the magnetic head 34 can perform stable information recording and reproduction.

In the spindle motor 18, the first and second radial dynamic pressure generating portions are arranged so that they are spaced and lapped in the radial direction of the fixed shaft 50 without overlapping in the axial direction of the shaft. Therefore, the dimension of the spindle motor in the axial direction of the shaft 50, that is, its height, can be reduced to miniaturize the motor. Further, the respective dynamic pressure generation centers a and b of the first and second radial dynamic pressure generating portions are deviated from each other by the distance h in the axial direction of the shaft 50. Accordingly, the rotating sleeve 52 can be prevented from swinging or tilting around the radial dynamic pressure generating portions, so that the hub 56 and the sleeve 52 can be supported and rotated with stability.

Thus, the hub and the magnetic disk can be supported stably, and the resulting spindle motor can be reduced in size. Further, there may be obtained a small-sized magnetic disk apparatus that ensures stable information recording and reproduction.

In the second embodiment described above, the first radial dynamic pressure generating portion is not limited to the outer peripheral surface of the fixed shaft, and may be formed of dynamic pressure generating grooves that are formed on the inner peripheral surface of the rotating sleeve or on both these peripheral surfaces. The second radial dynamic pressure generating portion is not limited to the outer peripheral surface of the rotating sleeve, and may be formed of dynamic pressure generating grooves that are formed on the inner peripheral surface of the outer ring member or on both these peripheral surfaces. The first thrust dynamic pressure generating portion is not limited to the first opposite surface of the outer ring member, and may be formed of dynamic pressure generating grooves that are formed on the first end face of the rotating sleeve or on both these surfaces. Further, the second thrust dynamic pressure generating portion is not limited to the second end face of the rotating sleeve, and may be formed of dynamic pressure generating grooves that are formed on the second opposite surface of the stopper sheet or on both these surfaces.

The present invention is not limited directly to the embodiments described above, and various changes or modifications may be effected therein without departing from the scope of the invention. Further, various inventions may be made by suitably combining a plurality of components described in connection with the foregoing embodiments. For example, some of the components according to the foregoing embodiments may be omitted. Furthermore, the components according to the different embodiments may be combined as required.

In the embodiments described herein, for example, the magnetic member of the magnetic attraction portion is not limited to the bottom wall of the case, and an alternative magnet member separate from the bottom wall may be opposed to the magnet. In this case, the bottom wall of the case may be formed of a nonmagnetic material, such as aluminum. Further, the present invention is not limited to magnetic disk apparatuses, and may be also applied to any other disk apparatuses, such as optical disk apparatuses.

1. A spindle motor comprising:
a fixed shaft at least one end of which is fixed;
a rotating sleeve which is rotatably arranged outside the fixed shaft and which has an inner peripheral surface opposed to an outer peripheral surface of the fixed shaft across a first fine gap, an outer peripheral surface, and a bottom surface extending between the inner and outer peripheral surfaces and;
an outer ring member which is provided fixedly and which has an opposite surface opposed to the bottom surface of the rotating sleeve across a second fine gap and an inner peripheral surface opposed to the outer peripheral surface of the rotating sleeve across a third fine gap;
a dynamic pressure generating fluid filled in the first, second, and third fine gaps;
a hub fixed to the rotating sleeve;
a magnetic attraction portion which has a magnet fixed to the hub and a magnetic member fixedly arranged and opposed to the magnet and urges the rotating sleeve in the axial direction of the fixed shaft and in a direction such that the second fine gap narrows, by a force of magnetic attraction between the magnet and the magnetic member;
a first radial dynamic pressure generating portion located singly in the first fine gap;
a second radial dynamic pressure generating portion located singly in the third fine gap; and
a thrust dynamic pressure generating portion located in the second fine gap.

2. The spindle motor according to claim 1, wherein a dynamic pressure generation center of the first radial dynamic pressure generating portion is spaced in the axial direction of the fixed shaft from a dynamic pressure generation center of the second radial dynamic pressure generating portion.

3. The spindle motor according to claim 1, which further comprises a stator coil opposed to the magnet and located outside the hub with respect to the radial direction thereof.

4. The spindle motor according to claim 1, wherein the first and third fine gaps individually have open ends open to the atmosphere and closed ends communicating with each other through the second fine gap.

5. The spindle motor according to claim 1, wherein the first radial dynamic pressure generating portion has dynamic pressure generating grooves formed on at least one of the outer peripheral surface of the fixed shaft and the inner peripheral surface of the rotating sleeve, the second radial dynamic pressure generating portion has dynamic pressure generating grooves formed on at least one of the outer peripheral surface of the rotating sleeve and the inner peripheral surface of the outer ring member, and the thrust dynamic pressure generating portion has dynamic pressure generating grooves formed on at least one of the bottom surface of the rotating sleeve and the opposite surface of the outer ring member.

6. A spindle motor comprising:
a fixed shaft at least one end of which is fixed;
a rotating sleeve which is rotatably located outside the fixed shaft and which has an inner peripheral surface opposed to an outer peripheral surface of the fixed shaft across a first fine gap, an outer peripheral surface, a first end face extending between the inner and outer peripheral surfaces, and a second end face spaced in the axial direction of the fixed shaft from the first end face and extending between the inner and outer peripheral surfaces;
an outer ring member which is fixedly arranged and which has a first opposite surface opposed to the first end face of the rotating sleeve across a second fine gap, an inner peripheral surface opposed to the outer peripheral surface of the rotating sleeve across a third fine gap, and a second opposite surface opposed to the second end face of the rotating sleeve across a fourth fine gap;
a dynamic pressure generating fluid filled in the first, second, third, and fourth fine gaps;
a hub fixed to the rotating sleeve;
a first radial dynamic pressure generating portion located singly in the first fine gap;
a second radial dynamic pressure generating portion located singly in the third fine gap;
a first thrust dynamic pressure generating portion located in the second fine gap; and
a second thrust dynamic pressure generating portion located in the fourth fine gap.

7. The spindle motor according to claim 6, wherein a dynamic pressure generation center of the first radial dynamic pressure generating portion is spaced in the axial direction of the fixed shaft from a dynamic pressure generation center of the second radial dynamic pressure generating portion.

8. The spindle motor according to claim 6, wherein the first and fourth fine gaps individually have open ends open to the atmosphere, the first and third fine gaps individually have closed ends communicating with each other through the second fine gap, and the fourth fine gap has a closed end communicating with the third fine gap.

9. The spindle motor according to claim 6, wherein the first radial dynamic pressure generating portion has dynamic pressure generating grooves formed on at least one of the outer peripheral surface of the fixed shaft and the inner peripheral surface of the rotating sleeve, the second radial dynamic pressure generating portion has dynamic pressure generating grooves formed on at least one of the outer peripheral surface of the rotating sleeve and the inner peripheral surface of the outer ring member, the first thrust dynamic pressure generating portion has dynamic pressure generating grooves formed on at least one of the first end face of the rotating sleeve and the first opposite surface of the outer ring member, and the second thrust dynamic pressure generating portion has dynamic pressure generating grooves formed on at least one of the second end face of the rotating sleeve and the second opposite surface of the outer ring member.

10. The spindle motor according to claim 6, which further comprises a magnetic attraction portion which has a magnet fixed to the hub and a magnetic member fixedly opposed to the magnet and urges the rotating sleeve in the axial direction of the fixed shaft and in a direction such that the second fine gap narrows, by a force of magnetic attraction between the magnet and the magnetic member.

11. The spindle motor according to claim 10, which further comprises a stator coil opposed to the magnet and located outside the hub with respect to the radial direction thereof.

12. A disk apparatus comprising:
a disk-shaped recording medium; and
a spindle motor according to any one of claims 1 to 11 which supports and drives the recording medium.
